(19) United States
(12) Patent Application Publication
(10) Pub. No.: US 2008/0100947 A1
(43) Pub. Date: May 1, 2008

(54) Magnetic recording and playback method and magnetic recording and playback apparatus

(76) Inventors: Shinichi Fukuda, Kanagawa (JP); Hidetoshi Honda, Miyagi (JP); Yoshihiko Deoka, Tokyo (JP); Yoshimi Mikami, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/640,801

(22) Filed: Dec. 18, 2006

(30) Foreign Application Priority Data
Nov. 1, 2006 (JP) 2006-003138

(51) Int. Cl. G11B 15/14

(52) U.S. Cl. 360/64

(57) ABSTRACT

A magnetic recording and playback apparatus that is configured to carry out recoding on and playback of a tape-like recording medium using a magnetic head mounted on a rotating drum by employing helical scanning is provided. The apparatus includes a multi recording head configured to record a plurality of tracks while a head chip carries out one scanning operation and a multi playback head configured to obtain a plurality of playback signals while the head chip carries out one scanning operation. The multi playback head is disposed so that tracks overlap by one channel in the head-width direction. The tape transporting speed for playback is slower than the tape transporting speed for recording.

### CROSS REFERENCES TO RELATED APPLICATIONS

The present invention contains subject matter related to Japanese Patent Application JP 2006-003138 filed in the Japanese Patent Office on Jan. 11, 2006, the entire contents of which are incorporated herein by reference.

### BACKGROUND OF THE INVENTION

1. Field of the Invention

The present invention relates to a magnetic recording and playback method, a magnetic recording and playback apparatus, and a tape drive apparatus employing the same and, more specifically, relates to a technology for providing, at low cost, a magnetic recording and playback apparatus that has a high recording density by disposing a plurality of magnetic heads (hereinafter, includes both magnetic recording heads and magnetic playback heads) (hereinafter referred to as ‘providing a multi magnetic head’).

2. Description of the Related Art

Recently, in association with magnetic heads, high-density recording has been required for increasing the capacity of magnetic recording media, and, thus, magnetic heads suitable for recoding tracks whose widths have been reduced (hereinafter, referred to as ‘width narrowing’) have been employed.

By carrying out high-density recording, more accurate track servo is required. Since, in general, the substrate of a magnetic tape is made of a plastic material, the bending of the tape, including deformation due to long-term storage, must be presumed to be 15 μm or more with respect to, for example, Sony's AIT-3 with a track width of 5.5 μm, and a strong track servo is required. Therefore, systems that employ a so-called double azimuth method for tolerating some degree of displacement of the servo and that are unable to playback signal from adjacent tracks even when the playback head moves greatly onto the adjacent tracks because of signal attenuation due to the azimuth effect have commonly been put to practical use.

As a measure against the difficulty in servo operation due to width narrowing, a so-called non-track system has been proposed and put to practical use. More specifically, Japanese Patent Nos. 1842057, 1842058, and 1842059 describe the basics of a non-tracking method. According to the non-tracking method, data is recorded on a track by carrying out double azimuth recording by helical scanning in a manner such that the track is segmented into a plurality of blocks and the data is identifiable by each block. In this way, data can be reconfigured even when a target track is not played back at once. Accordingly, a margin of more than four times of that of track control over one track required by a known track servo has been achieved.

Japanese Unexamined Patent Application Publication Nos. 04-370580 and 05-20788 propose signal recording methods based on a non-tracking playback method.

There has been studies carried out on the possibility of applying a non-tracking technology to, not only helical scanning, but also to linear recording, and propositions have been made in documents such as Japanese Unexamined Patent Application Publication Nos. 10-283620 and 2003-132504.

Also, there has been a need to provide a plurality of channels (i.e., multi channels) so as to realize high-capacity and high-density magnetic recording and to provide a multi magnetic head.

As a magnetic head device including a multi magnetic head, for example, a device constructed by stacking a plurality of magnetic recording head elements or a plurality of magnetic playback head elements on one head substrate with a magnetic shield layer and an insulating layer interposed therebetween has been proposed. More specifically, the magnetic head device described in Japanese Unexamined Patent Application Publication No. 2002-216313 relates to a magnetic recording head device, and the magnetic head device described Japanese Unexamined Patent Application Publication No. 2002-157710 relates to a magnetic playback head device.

Either magnetic head device is constructed by stacking a plurality of magnetic recording head layers or a plurality of magnetic playback head layers on a substrate made of non-magnetic material and displacing all magnetic head elements in a direction substantially orthogonal to the stacking direction (hereinafter, referred to as the head-width direction).

In this way, a multi magnetic head can be provided, and the magnetic heads can be disposed close to each other or in a manner such as to overlap with each other in the head-width direction so as to correspond to the narrowing of the recording tracks.

The main advantage of using a non-tracking method according to these previous inventions is that a large track control margin can be obtained for playback. However, when a multi head is provided, to cover the width scanned by the multi head, for example, as described in Japanese Unexamined Patent Application Publication No. 2003-132512, the width of the head chip is set to overlap with the width covered by one scanning operation, including at least the displacement range of the track control, or otherwise, as described in Japanese Patent No. 1842057, one track is scanned twice with the head to prevent skipping data in the tracks.

U.S. Pat. No. 6,307,701 describes a case in which the tape transporting speed is changed for recording and playback when employing a non-tracking method. Japanese Unexamined Patent Application Publication No. 2004-246949 describes a case in which the number of playback heads provided is greater than the number of tracks recorded at once.

### SUMMARY OF THE INVENTION

To carry out high-density magnetic recording with a head chip including a plurality of heads by employing the related art, when so-called double azimuth recording is carried out, the width of the playback head can be set the same as that of the recording track since the level of the signal of the track having a low head sensitivity can be reduced. In contrast, however, to prevent omission of a part corresponding to signals whose sensitivity is low, two playback heads must be disposed in substantially the same position. To achieve the same result, instead, scanning must be carried out while doubling the speed of the scanner on which a head is mount.

This indicates that, to achieve the same data transfer rate for recording and playback, a system cannot be established unless data writing is carried out during recording at half the speed of playback, and, such a system is not preferable for efficient recording and playback of data. Actually, to achieve the same rotational speed for the scanner, one of the azimuths carries out adjustment of the system such that data is written in only one track during two cycles. However, there is no change in that data is recorded at substantially half the speed of the ability of the system so as to match the data transfer speed during playback.

Furthermore, U.S. Pat. No. 6,307,701 proposes a method of changing the tape transporting speed during recording and playback when using a non-tracking system, but normally the tape transporting speeds for recording and playback are the same, and only when playback is impossible due to bending of the tape and so on, the tape transporting speed is changed to maintain the error rate. Thus, the tape transporting speed is not changed to increase the data transfer speed during recording but to reduce the data transfer speed during playback.

According to the technology described in Japanese Unexamined Patent Application Publication No. 2004-246949, by providing a number of playback heads equal to at least the number of tracks recorded at once plus α, playback can be carried out without sacrificing the transfer speed. However, when put to actual use, the maximum number of multi heads to be mounted on the head is the number of multi heads that can be mounted on the playback chip. Therefore, this is not suitable for increasing the recording density by increasing the number of heads to be used during recording.

The present invention has been conceived in the light of the problems described above and provides a magnetic recording and playback method and a magnetic recording and playback apparatus that are capable of making maximum use of the recording speed and achieving the best performance at low costs by minimizing the reduction of playback speed while preventing the playback system from becoming complex.

The present inventors have carried out studies for realizing a system that makes full use of the data transfer speed at low costs by employing a non-tracking method using a magnetic tape so as to increase the recording density. As a result, the inventors have provided the following solutions for establishing a simple system having maximum recording speed while minimizing the reduction of playback speed.

More specifically, in a non-tracking system using a multi recording head, by using two groups of the same number of playback heads as the number of recording heads included in the multi recording head, disposing these playback heads so that part of them overlap, and setting the transporting speed of the head unit for playback slower than that for recording, the recording speed can be maximized, and a reduction in the playback speed can be minimized without causing the system for playback to be complicated. In this way, a system that is capable of maximum performance can be provided at low cost.

A magnetic recording and playback method according to an embodiment of the present invention is for carrying out recoding on and playback of a tape-like recording medium using a magnetic head mounted on a rotating drum by employing helical scanning, the method including the steps of recoding a plurality of tracks using a multi recording head while carrying out one scanning operation of a head chip, and obtaining a plurality of playback signals using a multi playback head while carrying out one scanning operation of the head chip, wherein the multi playback head is disposed so that tracks overlap by one channel in the head-width direction, and wherein the tape transporting speed for playback is slower than the tape transporting speed for recording.

According to the above-described method, the number of the multi playback head may be twice the number of the multi recording head.

According to the above-described method, the number of playback heads included in the multi playback head may be twice the number of recording heads included in the multi recording head.

According to the above-described method, the number of playback heads included in the multi playback head may be one or more times to less than two times of the number of recording heads included in the multi recording head.

According to the above-described method, the azimuth directions of recoding heads included in the multi recording head may be the same.

According to the above-described method, the width of each recording head included in the multi playback head may be ½ or smaller than the width of a recording track, and the distance between the playback heads included in the multi playback head may be ½ of the width of the recording track.

A magnetic recording and playback apparatus according to an embodiment of the present invention is configured to carry out recoding on and playback of a tape-like recording medium using a magnetic head mounted on a rotating drum by employing helical scanning, the apparatus includes a multi recording head configured to record a plurality of tracks while a head chip carries out one scanning operation and a multi playback head configured to obtain a plurality of playback signals while the head chip carries out one scanning operation, wherein the multi playback head is disposed so that tracks overlap by one channel in the head-width direction, and wherein the tape transporting speed for playback is slower than the tape transporting speed for recording.

According to the above-described apparatus, the number of the multi playback head may be twice the number of the multi recording head, and the number of playback heads included in each of the multi playback heads may be the same as the number of recoding heads included in the multi recording head.

According to the above-described apparatus, the number of playback heads included in the multi playback head may twice the number of recording heads included in the multi recording head.

According to the above-described apparatus, the number of playback heads included in the multi playback head may be one or more times to less than two times of the number of recording heads included in the multi recording head.

According to the above-described apparatus, the azimuth directions of recoding heads included in the multi recording head may be the same.

According to the above-described apparatus, the width of each recording head included in the multi playback head may be ½ or smaller than the width of a recording track, and the distance between the playback heads included in the multi playback head may be ½ of the width of the recording track.

More specifically, a system including a multi recording head constituted of a plurality of recording heads disposed on a chip, the system being capable of carrying out playback according to a non-tracking method and recording a plurality of tracks simultaneously by one scanning operation carried out by a scanner is provided. For recording, a plurality of recording heads having the same azimuth are disposed, and recording is carried out at a single speed, which is the same as that according to a system in which a non-tracking system is not used. For playback, two playback units are used, where each unit includes the same number of playback heads as the number of recording heads included in a head block used for recording and the width of each playback head is substantially half the width of the recording track width. The heads of each unit are disposed so that only one channel overlaps and the number of multi-channels heads is minimized by reducing the tape transporting speed by, for example, two-thirds, so as to prevent tracking mistakes during playback.

According to embodiments of the present invention, the recording speed can be minimized and the reduction in playback speed can be minimized without making the system for playback complicated. In this way, power consumption can be reduced, and, as a result of a reduction in power consumption, incidental units can be simplified. Consequently, a magnetic recording and playback method that is low cost and that maximizes performance can be provided.

According to embodiments of the present invention, the recording speed can be minimized and the reduction in playback speed can be minimized without making the system for playback complicated. In this way, power consumption can be reduced, and, as a result of a reduction in power consumption, incidental units can be simplified. Consequently, a magnetic recording and playback apparatus that is low cost and that has maximized performance can be provided.

### BRIEF DESCRIPTION OF THE DRAWINGS

FIG. 1 is a plan view illustrating the overview of a magnetic recording and playback apparatus according to an embodiment of the present invention;

FIG. 2 is a schematic view illustrating the attachment state of a magnetic head device according to an embodiment of the present invention;

FIGS. 3A and 3B illustrates a recording head section according to an embodiment of the present invention, where FIG. 3A is a schematic view illustrating the relationship between the recording head and recording tracks, and FIG. 3B is schematic view illustrating a recording pattern;

FIG. 4 is a schematic view illustrating the relationship between a playback head and recorded tracks according to an embodiment of the present invention;

FIG. 5 is a schematic view illustrating the trajectory of the playback head with respect to a recorded track when the scanning speed is the same as the recording speed;

FIG. 6 is a schematic view illustrating the trajectory of the playback head with respect to a recorded track when the scanning speed is variable according to an embodiment of the present invention;

FIGS. 7A and 7B are schematic views illustrating a playback waveform obtained according to an embodiment of the present invention;

FIGS. 8A and 8B are schematic views illustrating a playback waveform obtained according to the related art;

FIG. 9 is a schematic view illustrating the attachment state of a magnetic head device according to another embodiment of the present invention; and

FIG. 10 is a schematic view illustrating the attachment state of a magnetic head device according to another embodiment of the present invention.

### DESCRIPTION OF THE PREFERRED EMBODIMENTS

Embodiments of the present invention will be described in detail below with reference to the drawings. However, the scope of the present invention is not limited to the embodiments described below.

### First Embodiment

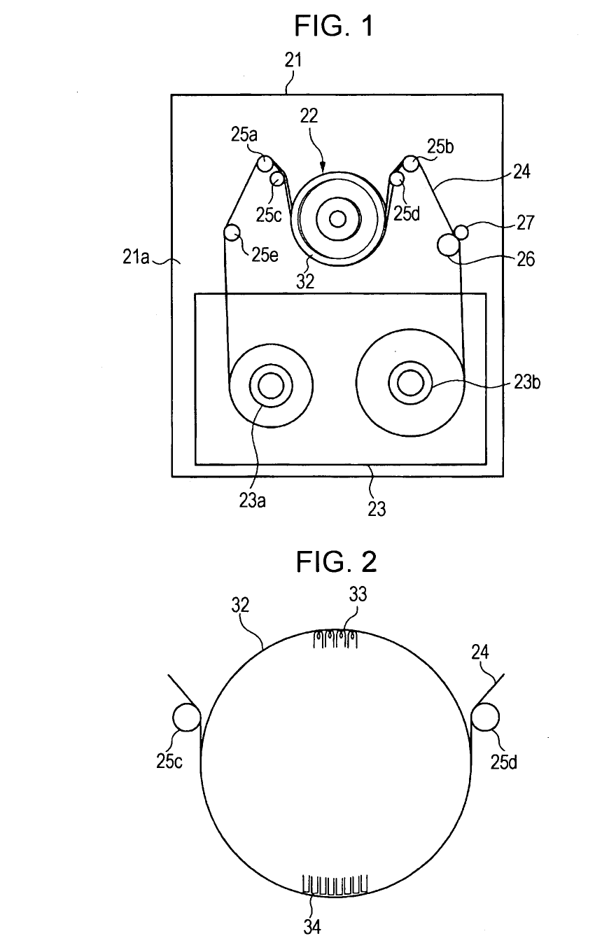

FIGS. 1 and 2 illustrates an embodiment of the present invention, where FIG. 1 is a schematic plan view of a magnetic recording and playback apparatus according to an embodiment of the present invention and FIG. 2 is a schematic view of a magnetic head device. A magnetic recording and playback apparatus 21, illustrated in these drawings, includes a rotating head drum device 22, tape guides 25a to 25e that form a predetermined tape path by pulling out a magnetic tape (tape-like recording medium) 24 from a tape cassette 23 having a supply reel 23a and a winding reel 23b and by winding the magnetic tape 24 around the rotating head drum device 22, and a capstan shaft 27 that moves in conjunction with a pinch roller 26 so as to transport the magnetic tape 24.

The rotating head drum device 22 is disposed in manner such that the shaft center is slightly tiled with respect to a chassis 21a. When the tape cassette 23 is installed, the magnetic tape 24 is pulled out from the tape cassette 23 to the rotating head drum device 22 by the tape guides 25a to 25e, is wound around a rotating drum 32, and, is sent between the pinch roller 26 and capstan shaft 27 so as to form the tape path.

In this state, by rotating the rotating head drum device 22 and the capstan shaft 27, the magnetic tape 24 is transported at a constant speed. As shown in FIG. 2, recording is carried out at a recording head section 33 mounted on the rotating drum 32 of the rotating head drum device 22, and playback is carried out by a playback head section 34 disposed 180° oppose to the recording head section 33.

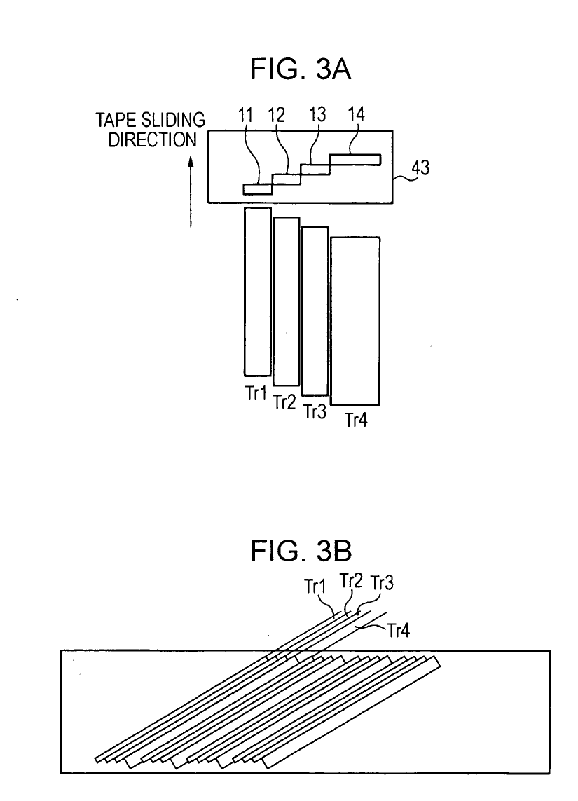

The recording head section 33, as shown in FIG. 3A, includes a recording head chip 43 (multi recording head) constructed by stacking four recoding heads 11 to 14 in the head-width direction (i.e., track-width direction of the magnetic tape 24) so that they do not overlap each other,.

By scanning the recording head chip 43 once, four tracks (Tr1 to Tr4) are recorded. The recording pattern, as shown in FIG. 3B, is such that the tracks Tr1 to Tr3 (i.e., recording tracks recorded by recording heads 11 to 13, respectively) are recorded with a track width of 2 μm and only the track Tr4 (i.e., the recording track recorded by recording head 14) is recorded with a track width of 3 μm.

This is for obtaining a so-called track margin. In this way, even when the scanning interval becomes small because of unevenness in the scanning carried out during recording, causing the track Tr4 recorded during the nth scanning and the Tr1 track recorded during the n+1 th scanning to overlap each other, the track Tr4 recorded during the nth scanning can be secured since the track width of the track Tr4 is large (so as to include the track margin).

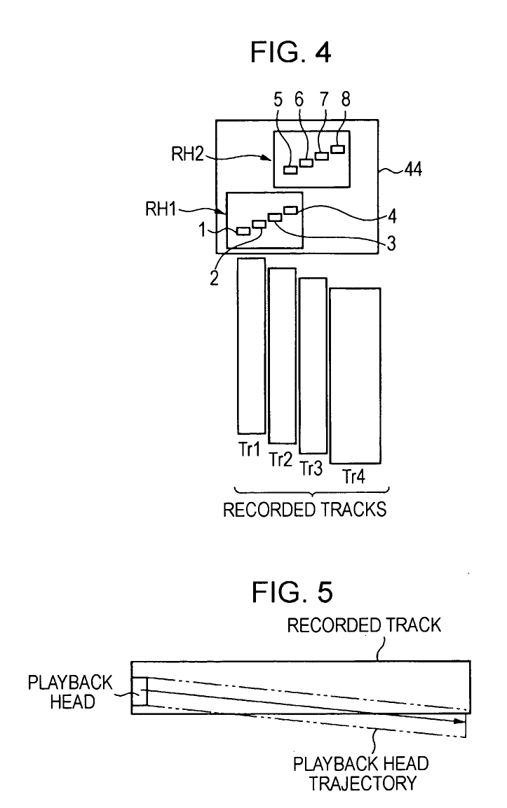

As shown in FIG. 4, the playback head section 34 includes a playback head chip 44 (multi playback head). The playback head chip 44 includes a head unit RH1 that is constructed by stacking four giant magnetoresistive (GMR) heads (i.e., heads constructed of GMR elements having a giant magnetoresistance effect) 1 to 4 (playback magnetic heads) in the head-width direction so that they do not overlap each other and a head unit RH2 that is constructed by stacking four GMR heads 5 to 8 (playback magnetic heads) in the head-width direction so that they do not overlap each other. In the playback head chip 44, the head unit RH1 and the head unit RH2 are disposed adjacent to each other in the tape sliding direction and in a manner such that tracks overlap by one channel or, in other words, the GMR head 4 and the GMR head 5 overlap in the head-width direction.

The head width (track width) of each of the GMR playback heads 1 to 8 is ½ or smaller than the head width of each of the recording heads 11 to 14. The interval of the GMR playback heads 1 to 4 and 5 to 8 in the track-width direction is ½ of the width of the recording track (for example, Tr1).

According to this embodiment, only one unit of the recording head chips 43 (multi recording head) is provided, and every time the recording head chips 43 makes a full rotation, the tracks are forwarded at a pitch of 9 μm. The recording speed depends only on the recording heads, and, for example, when two units of multi recording heads are disposed, the tracks may be forwarded by 18 μm for every full rotation. More than two units of heads may be used to correspond to high-speed recording.

As illustrated in FIG. 5, the trajectory of the playback head when the tape transporting speed during playback is simply reduced to match the scanning speed during recording diagonally intersects the recording tack. When put to practical use, it is not a problem for the data to be recorded in a manner such as to intersect with heads since non-tracking playback is carried out. However, as described below, when processing the data, it is desirable that the data to be read out by one head be continuous.

To achieve this, the transporting speed of the tape is changed, and, at the same, the scanning speed is reduced by the same rate. According to this embodiment, if the rotational speed for scanning during recording is 6,000 rpm and the track forwarding during playback, i.e., the playback pitch, is set to 6 μm, the rotational speed during playback may be set to 4,000 rpm.

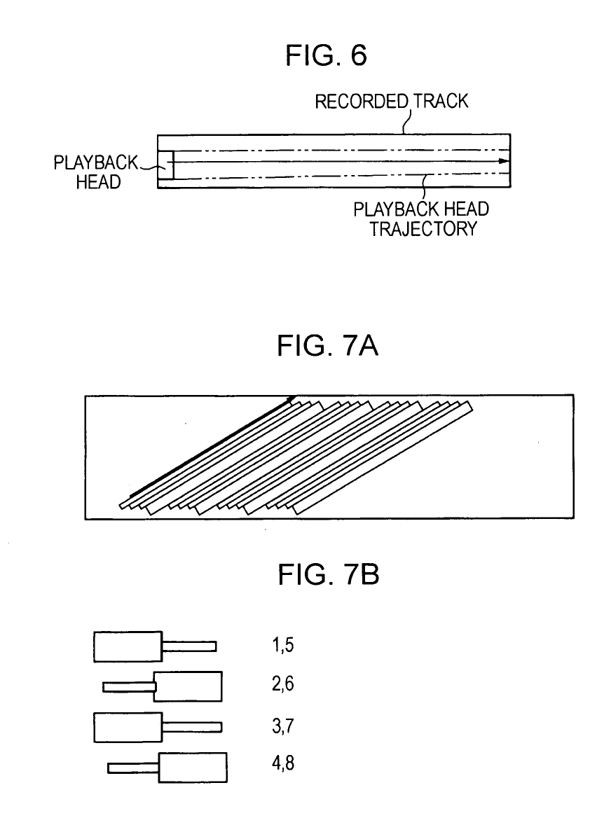

In this way, a playback head moving across a track will follow a trajectory along the track, as illustrated in FIG. 6. When the playback pitch is set to 6 μm, the width covered by the two units of head units RH1 and RH2, including width of the overlap, is 7 μm, and the track is scanned by a width greater than the playback pitch. Accordingly, data can be reliably played back in once scanning operation.

FIGS. 7A and 7B are schematic views of the playback waveform envelope at this time. According to this embodiment, since the head are disposed at positions 180° opposite to each other, a continuous waveform envelope, as that illustrated in FIG. 7B, is obtained by switching between a n channel and a n+4 channel (n=1, 2, 3, 4).

As a circuit for processing such signals, a proprietary circuit, for example, a programmable logic device (PLD), is used with an optimal configuration. In association with the circuit configuration, since this embodiment and the following comparative examples employ substantially the same systems, it is presumed that the configuration of the PLD does not affect the characteristic features.

U.S. Pat. No. 6,307,701 describes a method of adjusting the track trajectory by changing the tape transporting speed. According to the method described in U.S. Pat. No. 6,307,701, when data cannot be read out, the rotational speed of scanning is maintained constant while only the tape transporting speed is changed. Thus, in a normal state, the tape transporting speeds are the same for both recording and playback and differ only when a problem occurs. In other words, in a normal state, the trajectory of a head moving across a recording track at constant speed is equivalent to that illustrated in FIG. 6. In contrast, according to this embodiment of the present invention, the head trajectory illustrated in FIG. 6 is obtained by changing the tape transporting speed and the rotational speed of scanning so as to achieve high-density recording in a normal state. This is an essential difference from U.S. Pat. No. 6,307,701.

### FIRST COMPARATIVE EXAMPLE

Next, as a first comparative example, a system having substantially same performance as that according to the related art was provided. This system was substantially the same as that according to the first embodiment, except that the overlapping of the head unit RH1 and RH2 of the playback head chip 44 illustrated in FIG. 4 (i.e., the overlapping of the playback heads 5 and 6) was removed and the effective width was set to 8 μm. Moreover, the playback pitch was set to 8 μm that is the same as that for recording.

For the system according to the first comparative example, if it is possible to configure an ideal system, optimal cost effectiveness can be expected. However, in actuality, jittering caused by track forwarding generated thin areas in the recording track, causing the periodic generation of areas with small playback signals. Thus, the error rate worsened.

This was caused because the tape transporting speed was slow, or 12 mm per second, and it was difficult to suppress the tape displacement due to the rotational deviation of the capstan for controlling the tape transporting and slipping of the tape to 5 μm or smaller.

Substantially, since a track displacement of about 0.5 μm occurred, the output of one track was reduced by about 3 dB, and the error rate was worsened by one order of magnitude. Table 1 shows the actual error rate. Tracks A to D in Table 1 correspond to the tracks Tr1 to Tr4, respectively.

TABLE 1

| | First Comparative Example | | | | First Embodiment | | | |
|---|---|---|---|---|---|---|---|---|
| | Track | | | | | | | |
| | A | B | C | D | A | B | C | D |
| Average | 5 × 10⁻⁴ | 5 × 10⁻⁴ | 6 × 10⁻⁴ | 2 × 10⁻³ | 6 × 10⁻⁴ | 5 × 10⁻⁴ | 5 × 10⁻⁴ | 5 × 10⁻⁴ |
| Error | | | | | | | | |
| Rate | | | | | | | | |
| Worst | 7 × 10⁻⁴ | 9 × 10⁻⁴ | 9 × 10⁻⁴ | 7 × 10⁻³ | 9 × 10⁻⁴ | 9 × 10⁻⁴ | 8 × 10⁻⁴ | 8 × 10⁻⁴ |
| Error | | | | | | | | |
| Rate | | | | | | | | |

As apparent from Table 1, although the configurations are substantially the same, for the system according to the first comparative example that was constructed only on the basis of the related art, only the D track that is disposed at the rear edge has an error rate that is worse by one order of magnitude compared with other tracks, when the worst point is compared with the worst points of the other tracks. Therefore, since the error rate margin is significantly small, to actually employ this system with an error rate of 1×10⁻³ or smaller, which is the standard for actual use, large margins must be provided for the other tracks. Thus, it is difficult to increase the recording density.

### SECOND COMPARATIVE EXAMPLE

A second comparative example was provided by realizing the system according to Japanese Unexamined Patent Application Publication No. 2004-246949 by using the system according to the first embodiment, where only three channels of the recording head was used and two of the four channels (4 ch×2), i.e., the same number of those according to the first embodiment, for the playback head was used. The recording speeds and playback speeds of the second comparative example and the first embodiment are shown in Table 2.

TABLE 2

| | Second Comparative | |
|---|---|---|
| | Example | First Embodiment |
| Recording Speed | 6 MBps | 8 MBps |
| Playback Speed | 6 MBps | 6 MBps |

As apparent from Table 2, to realize the system proposed in Japanese Unexamined Patent Application Publication No. 2004-246949 (second comparative example), the recording speed is sacrificed when a similar system is employed. More specifically, when a similar system configuration is employed for the second comparative example, the playback speed becomes a bottleneck, and the recording speed will have to be matched thereto. In contrast, with the first embodiment, the recording speed can be set to high-speed when a system having substantially the same configuration is employed because the recording speed and the playback speed do not have to be matched. Accordingly, when the first embodiment and the second comparative example are compared, the first embodiment is advantageous in speed by about 30%. Consequently, it can be concluded that the system of the first embodiment has better performance when the performances of systems that substantially cost the same are compared, whereas, a more complex system must be configured for the second comparative example compared to that of the second comparative example when the performances of the systems are compared, and, thus, the cost of the second comparative example becomes higher.

### THIRD COMPARATIVE EXAMPLE

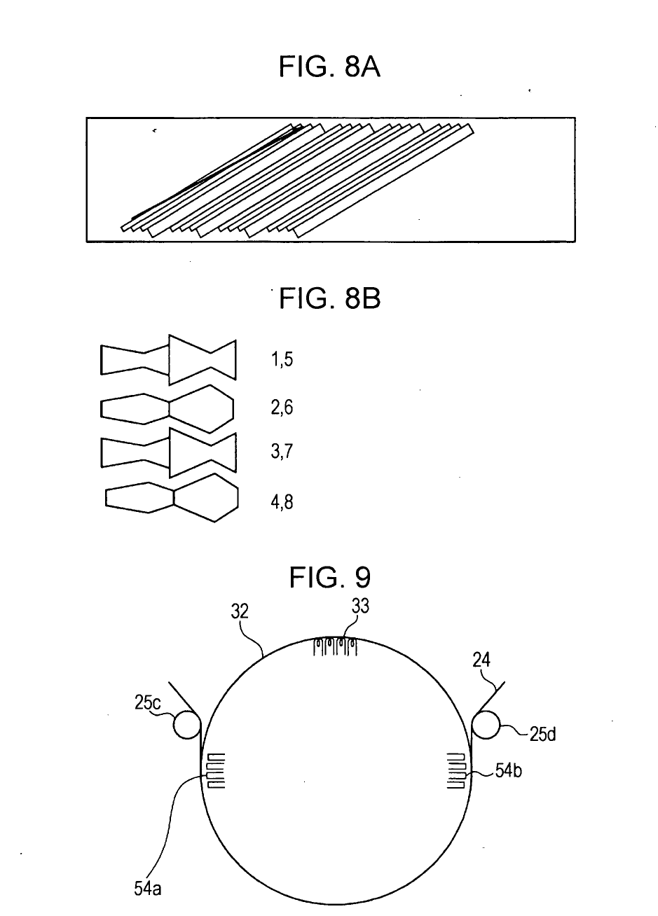

Next, as an example employing a known system, a system in which non-tracking is used and one track is scanned twice by a head was constructed as a third comparative example. The pattern of track scanning and the playback waveform envelope are illustrated in FIGS. 8A and 8B. The envelope illustrated in FIG. 8B indicates that a continuous waveform cannot be obtained.

To configure a system according to the third comparative example, there is a limitation in that the track pitch during recording must be suppressed. Moreover, since a signal is played back by the heads crossing over the tracks, the processing for reconfiguring the original data becomes complicated, causing an increase in power consumption. In addition, a case in which the rotational speed of the scanner is not reduced is provided as Embodiment 1-1, and the recording speed, the playback speed, and the power consumption are compared with other examples. The results are shown in Table 3.

TABLE 3

| | Third | | Second | | First | | | | | |
|---|---|---|---|---|---|---|---|---|---|---|
| | Comparative | | Comparative | | Comparative | | First | | | |
| | Example | | Example | | Example | | Embodiment | | Embodiment 1-1 | |
| Recording | 3 | MBps | 6 | MBps | 8 | MBps | 8 | MBps | 8 | MBps |
| Speed | | | | | | | | | | |
| Playback | 6 | MBps | 6 | MBps | 6 | MBps | 6 | MBps | 8 | MBps |
| Speed | | | | | | | | | | |
| Power | 19 | W | 15 | W | 12 | W | 12 | W | 15 | W |
| Consumption | | | | | | | | | | |
| (Average) | | | | | | | | | | |

As apparent from Table 3, for the third comparative example, the playback speed cannot be set to maximum speed unless the recording speed is set to half of that of the first embodiment, and since signal processing becomes complicated, power consumption is increased. A programmable logic device (PLD) provided as the configured signal processing circuit is capable of handling 8 MBps even when the signal is segmented. However, estimating from the power consumption of the first embodiment and the theoretical response speed of the PLD, it is presumed that up to 12 MBps can be handled. Thus, when the same circuits are used, the third comparative example can be used with a 50% margin. In other words, this indicates that the margin for reconfiguration is great even when the level of track control is lower than the track pitch accuracy, which is the original object of employing non-tracking. If power consumption of the configured system is great, the temperature rise of the drive of the configured drive system is increased, causing an increase in cost for configuring a system including a facility, such as a powerful cooling fan, for heat dissipation.

For Embodiment 1-1, power consumption is greater than the first embodiment because more steps are required in the processing for playback because playback is carried out by partially crossing over tracks. However, power consumption is smaller than that of the third comparative example.

The power consumption of the second comparative example that is a similar system as that of Embodiment 1-1 is substantially similar to that of Embodiment 1-1. However, in the case of the second comparative example, if the power consumption is the same, the transfer rate for recording must be set to a low rate, whereas if the recording rate and playback rate set faster than those of the first embodiment or Embodiment 1-1, power consumption is increased.

Although the first comparative example is equivalent to the first embodiment from a viewpoint of power consumption, the system according to the first comparative example cannot be put to use because, as shown in Table 1, there is a possibility that the error rate will be significantly bad.

### Second Embodiment

As illustrated in FIG. 9, a second embodiment of the present invention includes a recording head section 33 that is the same as that illustrated in FIG. 2 and that is mounted on a rotating drum 32 and two playback head sections 54a and 54b (multi playback head) that are mounted on both sides in the circumferential direction of the rotating drum 32 so that they are displace by 90° with respect to the rotating drum 32.

The playback head section 54a, for example, is provided with a playback head chip constructed by stacking four GMR heads 1 to 4 by displacing them in head-width direction, in the same manner as the head unit RH1 illustrated in FIG. 4. The playback head section 54b, for example, is provided with a playback head chip constructed by stacking four GMR heads 5 to 8 by displacing them in head-width direction, in the same manner as the head unit RH2 illustrated in FIG. 4.

The two units of playback head sections 54a and 54b are disposed at positions where the playback trajectory of the fourth GMR head 4 of the playback head section 54a and the playback trajectory of the first GMR head 5 of the playback head section 54b overlap.

The head width of each of the GMR playback heads 1 to 4 and 5 to 8 is ½ or smaller than that of the head width of each recording head 11 to 14. The interval in the track-width direction of the GMR playback heads 1 to 4 and 5 to 8 is half of that of the recording track (for example, Tr1 of FIG. 4).

According to the second embodiment, twice the number of playback head sections 54a and 54b (multi playback head) as the recording head section 33 (multi recording head) is provided on the recording head section 33, whereas the same number (four) of playback heads (1 to 4 or 5 to 8) of the playback head section 54a or 54b as the number of recording heads (11 to 14) of the recording head section 33 is provided. Recording and playback according to the second embodiment are carried out in the same manner as those according to the first embodiment.

More specifically, when the rotational speed for recording is set to, for example, 6,000 rpm and the rotational speed for playback is set to, for example, 4,000 rpm, for every cycle of the rotating drum 32, the track (magnetic tape) is forwarded at a pitch of, for example, 9 μm during recording whereas the track is forwarded at a pitch of, for example, 6 μm during playback. In this way, a continuous playback waveform such as that illustrated in FIG. 7B can be obtained according to the second embodiment.

Accordingly, a satisfactory error rate that is the same as that indicated by the numerical values according to the first embodiment shown in Table 1 can be achieved; the recording speed can be set advantageously in the same manner as the recording and playback speeds according to the first embodiment shown in Table 2; and power consumption can be reduced in the same manner as that according to the first embodiment shown in Table 3.

### Third Embodiment

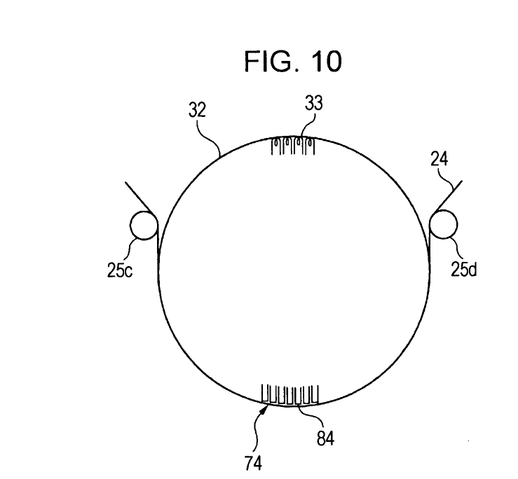

As illustrated in FIG. 10, a third embodiment of the present invention includes a recording head section 33 that is the same as that illustrated in FIG. 2 and that is mounted on a rotating drum 32 and a playback head section 74 (multi playback head) that is mounted opposite to the recording head section 33 by 180°.

The playback head section 74 includes a playback head chip 84 (multi playback head) that has, for example, a head unit RH1 that is constructed by stacking four GMR heads 1 to 4 in different directions in the head-width direction, in a manner similar to the head unit RH1 illustrated in FIG. 4, and, for example, a head unit RH2′ that is constructed by stacking three GMR heads 5 to 7 in different directions in the head-width direction provided adjacent to each other in the tape-sliding direction and in a manner such that only one channel of each track overlap each other or, in other words, in a manner such that the GMR head 4 and the GMR head 5 overlap each other in the head-width direction.

The head width of each of the GMR heads 1 to 4 and 5 to 7 is ½ or smaller than the head width of each of the recording heads 11 to 14. The interval in the track-width direction of the GMR playback heads 1 to 4 and 5 to 7 is half of that of the recording track (for example, Tr1 of FIG. 4).

According to the third embodiment, one to two times as many playback heads (1 to 7) of the playback head section 74 as the recording heads (11 to 14) of the recording head section 33 are provided, and recording and playback are carried out in the same manner as the first embodiment.

More specifically, when the rotational speed for recording is set to, for example, 6,000 rpm and the rotational speed for playback is set to, for example, 4,000 rpm, for every cycle of the rotating drum 32, the track (magnetic tape) is forwarded at a pitch of, for example, 9 μm during recording whereas the track is forwarded at a pitch of, for example, 6 μm during playback. In this way also, a continuous playback waveform such as that illustrated in FIG. 7 can be obtained according to the third embodiment.

Accordingly, a satisfactory error rate that is the same as that indicated by the numerical values according to the first embodiment shown in Table 1 can be achieved; the recording speed can be set advantageously in the same manner as the recording and playback speeds according to the first embodiment shown in Table 2; and power consumption can be reduced in the same manner as that according to the first embodiment shown in Table 3.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic recording and playback method of carrying out recoding on and playback of a tape-like recording medium using a magnetic head mounted on a rotating drum by employing helical scanning, the method comprising the steps of:
recoding a plurality of tracks using a multi recording head while carrying out one scanning operation of a head chip; and
obtaining a plurality of playback signals using a multi playback head while carrying out one scanning operation of the head chip,
wherein the multi playback head is disposed so that tracks overlap by one channel in the head-width direction, and
wherein the tape transporting speed for playback is slower than the tape transporting speed for recording.

2. The magnetic recording and playback method according claim 1, wherein,
the number of the multi playback head is twice the number of the multi recording head, and
the number of playback heads included in each of the multi playback heads is the same as the number of recoding heads included in the multi recording head.

3. The magnetic recording and playback method according claim 1, wherein the number of playback heads included in the multi playback head is twice the number of recording heads included in the multi recording head.

4. The magnetic recording and playback method according claim 1, wherein the number of playback heads included in the multi playback head is the same or more than one times to less than two times of the number of recording heads included in the multi recording head.

5. The magnetic recording and playback method according claim 1, wherein the azimuth directions of recoding heads included in the multi recording head are the same.

6. The magnetic recording and playback method according claim 1, wherein,
the width of each recording head included in the multi playback head is ½ or smaller than the width of a recording track, and
the distance between the playback heads included in the multi playback head is ½ of the width of the recording track.

7. A magnetic recording and playback apparatus configured to carry out recoding on and playback of a tape-like recording medium using a magnetic head mounted on a rotating drum by employing helical scanning, the apparatus comprising:
a multi recording head configured to record a plurality of tracks while a head chip carries out one scanning operation; and
a multi playback head configured to obtain a plurality of playback signals while the head chip carries out one scanning operation,
wherein the multi playback head is disposed so that tracks overlap by one channel in the head-width direction, and
wherein the tape transporting speed for playback is slower than the tape transporting speed for recording.

8. The magnetic recording and playback apparatus according claim 7, wherein,
the number of the multi playback head is twice the number of the multi recording head, and
the number of playback heads included in each of the multi playback heads is the same as the number of recoding heads included in the multi recording head.

9. The magnetic recording and playback apparatus according claim 7, wherein the number of playback heads included in the multi playback head is twice the number of recording heads included in the multi recording head.

10. The magnetic recording and playback apparatus according claim 7, wherein the number of playback heads included in the multi playback head is the same or more than one times to less than two times of the number of recording heads included in the multi recording head.

11. The magnetic recording and playback apparatus according claim 7, wherein the azimuth directions of recoding heads included in the multi recording head are the same.

12. The magnetic recording and playback apparatus according claim 7, wherein,
the width of each recording head included in the multi playback head is ½ or smaller than the width of a recording track, and
the distance between the playback heads included in the multi playback head is ½ of the width of the recording track.
